(19) United States
(12) Patent Application Publication
(10) Pub. No.: US 2014/0123505 A1
(43) Pub. Date: May 8, 2014

(54) SNAP-CAN OPENER

(71) Applicant: Puthalath Koroth Raghuprasad, Odessa, TX (US)

(72) Inventor: Puthalath Koroth Raghuprasad, Odessa, TX (US)

(21) Appl. No.: 13/668,783

(22) Filed: Nov. 5, 2012

(51) Int. Cl. B67B 7/48

(52) U.S. Cl. 30/445

(57) ABSTRACT

A can opener for cutting open a can lid has a body housing and a cutting blade. The cutting blade has a plurality of cutting teeth aligned along a circular perimeter inside said body housing. At least one first tooth has an internally facing projection for curling the cut lid. Preferably, the plurality of teeth extend around the perimeter to a spaced gap opposite the at least one first tooth with the projection. The plurality of cutting teeth are not aligned in a parallel plane relative to the lid during cutting. The cutting teeth having pointed ends arranged on an incline or curvature relative to the lid allowing for a progressive cutting of the lid with ease.

### TECHNICAL FIELD

The present invention relates to can openers generally, more particularly to a can opener with a plurality of cutting teeth.

### BACKGROUND OF THE INVENTION

Manually opening cans has been a difficult and oftentimes impossible task for those with wrist issues such as carpal tunnel syndrome.

Most manual can opening devices rely on a cutting wheel rotated by turning a handle. R. E. McLean in his 1949 patent disclosed such a device in U.S. Pat. No. 2,466,117 entitled “Rotary Feed Wheel Type Can Opener”. McLean then improved on that concept in U.S. Pat. No. 2,984,9044 with an improved can opener cutter wheel assembly having better traction and cutting, but still relying on a wrist operated rotatable handle to turn the cutting wheel to open the can.

The use of a cutting wheel was considered a great advance over early piercing or plunging type devices.

The advent of small electric motors started to be used in the 1950's and U.S. Pat. No. 2,979,815 granted to R. L. Rohde et al in Apr. 18, 1961 is an example of a rotary wheeled electric can opener. This type of electric can opener became very popular and is well accepted to this day. For many persons this solved the problem of opening a can when they were too weak or unable to rotate a handle because the electric can opener did all the work. Electric can openers nevertheless are prone to mechanical breakdowns and electrical failures.

Nevertheless, it is still believed that a can opener that can be made from a simple design concept requiring no rotatable handle and no electric motor is very desirable.

In some situations the person may not have access to electric power so battery-operated can openers may be an option, but even these devices are complicated and require charging.

Ideally one should be provided with a device that can cut open a can lid without requiring repetitive wrist manipulations or electric power.

In JP8164995 the use of cutting teeth in a can opener is taught. These teeth are all oriented parallel to the can lid requiring simultaneous contact which requires large forces to accomplish the cutting of the lid to open the can.

The present invention provides a clever and novel way to cut open a can lid in a safe and reliable way without any repetitive wrist motion required.

The present invention as described herein provides a simple and low cost can opener without the use of a rotating cutting wheel and manually rotatable handle.

### SUMMARY OF THE INVENTION

A can opener for cutting open a can lid has a body housing and a cutting blade. The cutting blade has a plurality of cutting teeth aligned along a circular perimeter inside said body housing. At least one first tooth has an internally facing projection for curling in the cut lid. Preferably, the plurality of teeth extend around the perimeter to a spaced gap opposite the at least one first tooth with the projection. The plurality of cutting teeth are not aligned in a parallel plane relative to the lid during cutting. The cutting teeth having pointed ends arranged preferably on an incline or curvature relative to the lid allowing for a progressive cutting of the lid.

The body housing has a top and a cylindrically shaped skirt extending downwardly from the top. The skirt is positioned to align the can body with the can opener.

The at least one first tooth oppositely spaced from the spaced gap has a cutting point extending inwardly deeper than the other teeth to provide an initial piercing of the lid prior to the remaining cutting teeth. The cutting blade has the points of the cutting teeth aligned linearly and inclined relative to the lid and extend from the tooth with a projection to the spaced gap at an angle other than 0 degrees relative to a can lid. Alternatively, the cutting blade can have the cutting teeth aligned on a curved path relative to the lid. The cutting blade is preferably affixed to the top inner surface of the body housing and spaced from the side skirts. The body housing is made of plastic, wood or metal. The cutting blade is made of metal or ceramic. The cutting blade edges are made of hardened metal having tungsten, carbide or diamond coated cutting teeth, the cutting edges being sharpened on one or both cutting edges. The cutting edges having internal cutting surfaces or external cutting surfaces or both.

### BRIEF DESCRIPTION OF THE DRAWINGS

The invention will be described by way of example and with reference to the accompanying drawings in which:

FIG. 1 is an external view of the device made in accordance with the present invention.

FIG. 2 is a second perspective view showing the underside of the device with the cutting blade shown in dashed lines where hidden from view.

FIG. 3 is a cross-sectional view of the device of FIG. 1 showing the cutting blade taken along section lines 3-3 of FIG. 4.

FIG. 4 is a plan bottom or underside view looking into the device of FIG. 1.

FIG. 5 is a sectional view of the device shown cutting through a lid of a can.

FIG. 6 is a view of the can after the device is removed showing the lid bent upwardly at the end cut by the tooth with a projection and affixed to the can at the location where a gap in the blade was positioned over the lid.

FIG. 7A is an exploded view of the device showing the outer body housing and the annular cutting blade separated.

FIG. 7B is a first embodiment cutting blade laid out flat so the curved profile of the teeth can be easily seen.

FIG. 7C is a second embodiment of the cutting blade laid out flat so the angled profile of the cutting teeth can be easily seen.

### DETAILED DESCRIPTION OF THE INVENTION

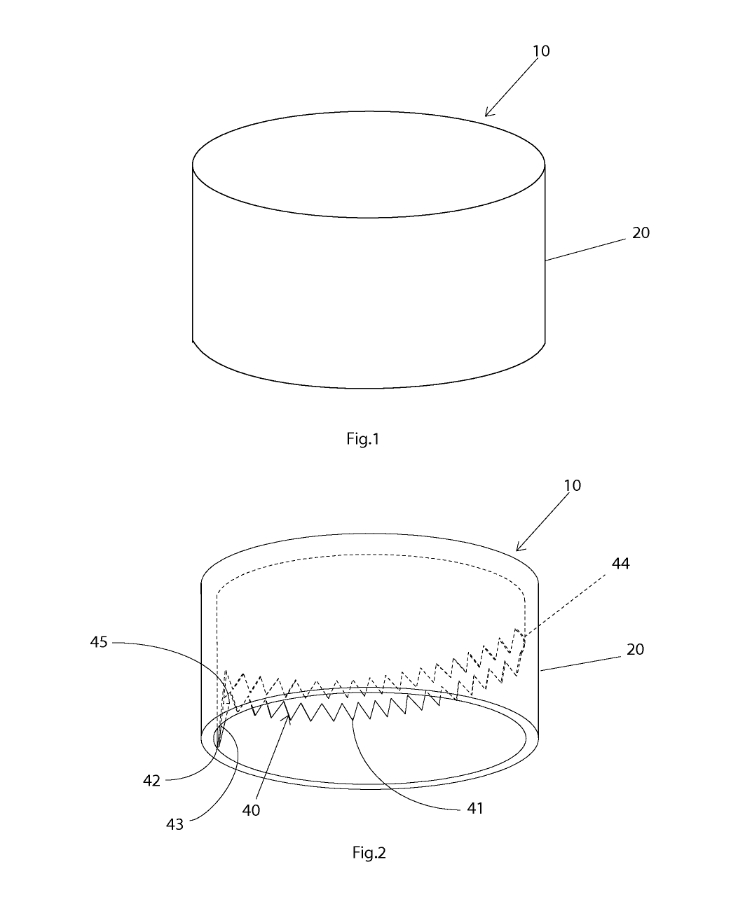

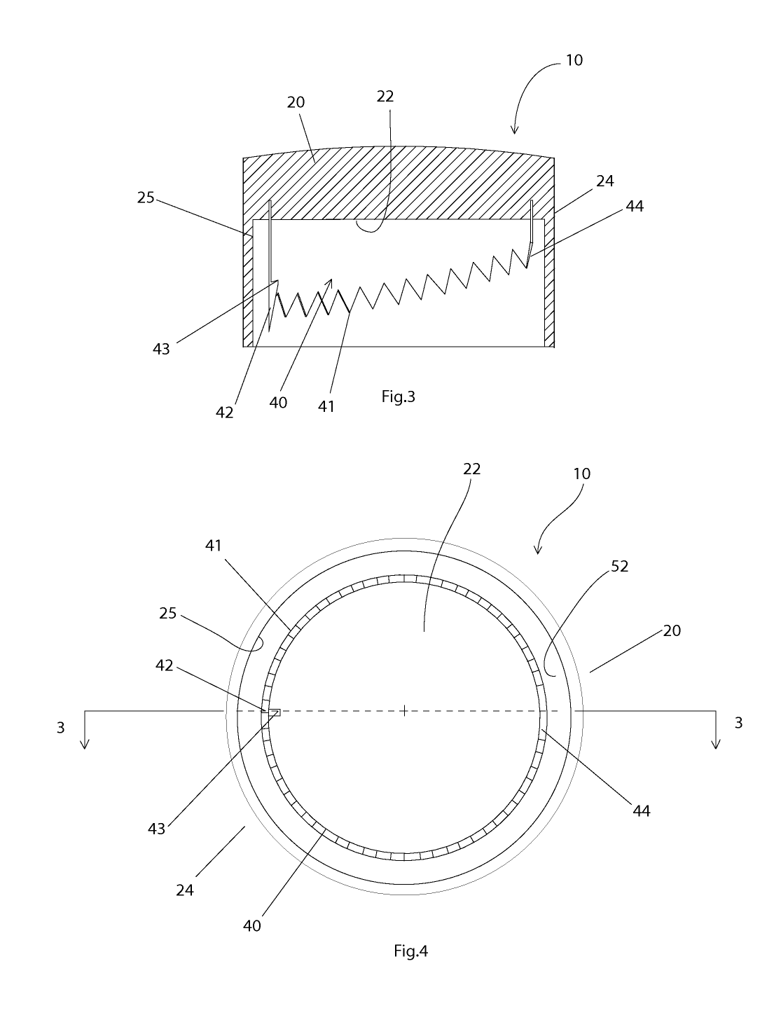

With reference to FIGS. 1 through 4, a can opener device 10 is illustrated. The can opener device 10 as shown in FIG. 1 has a body housing 20. The body housing 20 as shown has a top surface for a hand to apply a downward force and a side skirt 24 that runs annularly from the top surface around the peripheral side of the can opener device 10. As shown in FIG. 2, the skirt 24 encircles a large opening inside of the housing 20 which holds a cutting blade 40. The cutting blade 40 as illustrated is shown in an annular configuration. The cutting blade 40 has a first tooth 42 with a projection 43 on it shown extending inwardly from an inner surface of the first tooth 42. This projection 43 terminates at an upper surface creating an edge or lip 45. Adjacent the first tooth 42 are a plurality of cutting teeth 41. As shown, these cutting teeth 41 are positioned on a slightly curved or bowed profile extending around a circumference of the cutting blade 40 from the first tooth 42 to a spaced gap 44. The spaced gap 44 as illustrated does not cut into a can when the can opener device 10 is used. With reference to FIG. 3, a cross-sectional view is shown wherein the cutting blade 40 is better illustrated showing the plurality of cutting teeth 41 extending from the spaced gap 44 on one side to the first tooth 42 with the projection 43. The first tooth 42 lies on the opposite side or approximately 180 degrees apart from the gap 44. As shown, the body housing 20 has the cutting blade 40 affixed by insert molding or otherwise held securely into an internal upper surface 22 of the body housing 20. The cutting blade 40 is centered on the body housing 20 such that the skirt 24 and the cutting blade 40 are spaced sufficient to allow a can to be positioned there in-between. As further referenced in FIG. 4, the bottom view of the device 10 shows the cutting blade 40 with the spaced gap 44 on one side and the long tooth 42 on the opposite side.

The can opener device 10 is designed to be easily manufactured and is made to fit a particular can size. Can size standards are established in the US by the Can Manufacturers Institute or CMI.

Metal can sizes used in industry in the U.S.A. are derived from nominal outside dimensions. Measurements are made of the empty round can before seaming on the packers' end.

While such dimensions may be expressed in inches, the custom is to use a conventionalized method in which three-digit numbers are used to express each dimension. The first digit indicates the number of whole inches in a dimension, and the second and third digits indicate the fractional inches as sixteenths of an inch. Thus: 303×406 means 3 3/16×4 6/16 inches; 307×512 means 3 7/16×5 12/16 inches and 603×700 means 6 3/16×7 inches.

The first three-digit number describing a round can indicates the diameter measured across the outside of the chime on the seamed end. The second three-digit number indicates the overall height of the can with one end on.

In stating the dimensions of oval, obround, or obrotund cans, outside dimensions are used, the dimensions of the opening stated first, followed by the height. Thus, there will be three sets of figures: the first two being the long and short axis of the opening. Their interpretation in inches and sixteenths of an inch is the same as with round cans. An oval can might have the size given as 402×304×612, which would mean that the oval opening was 4 2/16×3 4/16 inches and the height was 6 12/16 inches.

Ideally, the can opener 10 of the present invention has a cutting blade diameter sized to fit just inside the rim of a can to permit the lid to be cut as close to the can wall as possible.

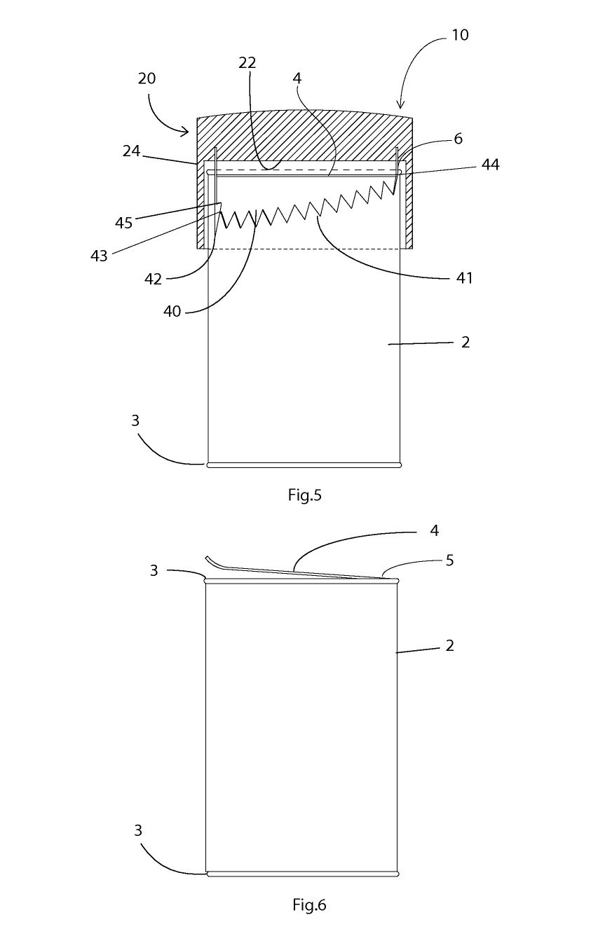

With reference to FIGS. 5 and 6, the can opener device 10 is shown in FIG. 5 positioned over a can 2 and slid downwardly into the cutting position. When fully extended downwardly, the plurality of cutting teeth 41 and the first tooth 42 cut the can lid 4 progressively in all locations except where the spaced gap 44 is positioned. At that location a small tab 6 will be remaining on the lid 4 as cut. With reference to FIG. 6, when the can opener device 10 is withdrawn from the can 2 that has just cut the lid 4 in a backward and upward direction, the lid 4 will be pulled upwardly and a portion of the lid 4 adjacent the long tooth 42 with the projection 43 will be bent upwardly by the edge or lip 45 as illustrated. This insures the opened can lid 4 is always exposed to the user so they can easily lift the lid 4 further upwardly bending the lid 4 against the tab to safely remove the contents from the can 2. As shown, the advantage of the present invention is that it can be used with a simple downward thrust of the can opener 10 against the can 2. There is no twisting or rotation requiring any manipulative force of the wrist; a simple downward load on the top of the can opener 10 will drive the teeth 41 into engagement with the lid 4 cutting it as the points of the teeth 41 pierce into the lid 4 cutting it as the cylindrical body 5 of the can 2 sitting on a flat surface provides resistance and support.

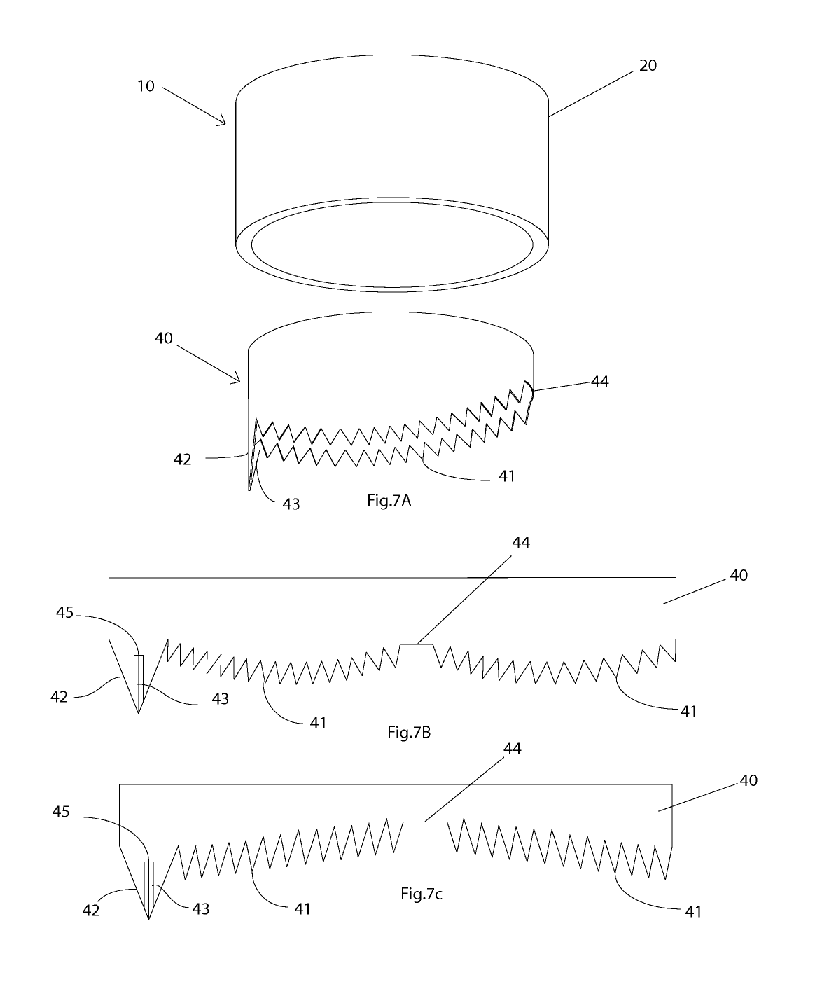

With reference to FIG. 7A, the body housing 20 is shown separate from the cutting blade 40 and the cutting blade 40 is shown as an annular ring having a curved profile of the teeth 41 extending from the first long tooth 42 with the projection 43 to the spaced gap 44 in the cutting blade 40 ring. As shown in FIG. 7B, this profile is laid flat so one can see that the points of the teeth have a curved profile. The curves extend from both sides of the long first tooth 42 in a curvature extending back to the spaced gap 44 which forms the tab 6 in the lid 4 when the can opener 10 is used. With reference to FIG. 7C, an alternative embodiment is shown wherein the cutting teeth 41 are all laid on an angle or straight incline extending from a highest point from the two teeth 41 adjacent the first tooth 42 with the projection 43 downwardly toward the spaced gap 44.

In use, it is believed important that the first tooth 42 be slightly longer than the adjacent plurality of cutting teeth 41; in this way the can lid 4 can first be pierced then as the first tooth 42 extends inwardly, the can lid 4 is slid up against the projection 43 and will snap into a top edge or lip 45 as the lid 4 passes that edge 45 locking it above the projection 43, as the remaining teeth 41 progressively come into contact with the lid 4. In the case illustrated in FIG. 7B of the curved or bowed cutting blade 40, contact is made with those teeth 41 that extend furthest. These teeth 41 are slightly spaced from the long cutting first tooth 42 and spaced from the gap 44 and therefore on each side of the can opener 10 only a few number of teeth 41 will make initial cutting or piercing contact with the lid 4 as the cutting progresses outwardly from both sides of these teeth 41 around the perimeter in such a fashion that the shorter or lower profile cutting teeth 41 will then come into engagement with the lid 4 in a rather progressive fashion. This minimizes the number of teeth 41 that are in direct contact with the lid 4 at any one time.

In FIG. 7C, the cutting blade 40 is shown on an angular inclination with the tallest or higher profile teeth 41 extending adjacent the first cutting tooth 42 wherein these teeth 41 become progressively shorter or lower in profile relative to the can lid 4. The blade 40 inclination becomes progressively shorter as the points of the teeth 41 extend to the spaced gap 44 such that the cutting by the teeth 41 occurs from adjacent the first tooth 42 and progressively extends around the periphery of the cutting blade 40 when in an annular configuration. In this case, the cutting occurs progressively from the first tooth 42 around to the spaced gap 44. It is believed important that in any configuration that one minimizes the number of teeth 41 in contact with the lid 4 as the blade 40 is cutting; in this way the amount of force required to pierce through the lid 4 is reduced. As used herein and shown, each of the teeth 41 is identical in shape, size and appearance; however, by positioning these teeth 41 on a curved or angled cutting path, the forces required to cut and open the lid 4 are greatly reduced. It is possible to vary the actual size of the teeth 41 to achieve a progressive cutting; however, this is not considered the best or optimal practice.

Had the teeth 41 been laid in a horizontal position, all of the teeth 41 would come into engagement with the lid 4 all at the same time. This results in a situation that demands maximum amount of force and the inventor believes that this would cause too much of a load to be placed upon the lid 4 causing the operator to use an excessive amount of force which is needlessly difficult. If the teeth 41 are positioned as shown in FIG. 7B or 7C where only a few cutting teeth 41 can come into engagement with the lid 4 as the lid 4 is progressively cut making the cutting much easier. In the illustrated embodiment of FIG. 7B, there are 32 cutting teeth 41. Assuming on each side of the can opener 10 there are sixteen teeth 41 and only two to four teeth 41 are actually cutting as the blade 40 engages the lid 4, then the amount of force required to progressively open a can 2 is only 12.5% to 25% that of a horizontal blade with all teeth 41 simultaneously engaging the lid 4. The dramatic reduction in load allows the can opener 10 to easily cut the lid 4.

While the device 10 is shown with the blade either a bowed curvature extending from the first tooth 42 extending to the spaced gap 44 while on an angular inclination it is understood other profiles can be provided to achieve this result such as a helical spiral or other profiles and they are considered within the scope of the present invention. Furthermore, while the first tooth 42 is shown extending further than the other adjacent plurality of cutting teeth 41, it is understood that this tooth 42 could be similarly positioned along any profile desired; however it is believed preferable that the tooth 42 with the cutting projection 43 be positioned approximately 180 degrees apart from the spaced gap 44 as illustrated. Alternatively, it is possible to build this device 10 such that there is no spaced gap 44 at all. In such a configuration if this spaced gap 44 is eliminated, the lid 4 will probably drop into the can 2. However, then an extraction device may be needed on the can to make sure that the captured lid 4 withdrawn from the can 2 can be removed from the can opener device 10. These and other alternative configurations are considered within the scope of the present invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described, which will be within the full intended scope of the invention as defined by the following appended claims.

What is claimed is:

1. A can opener comprises:
a body housing;
a cutting blade having a plurality of cutting teeth aligned along a circular perimeter inside said body housing; and
wherein at least one tooth has an internally facing projection for curling the cut lid and the plurality of cutting teeth are not aligned in a parallel plane relative to the lid during cutting, the cutting teeth having pointed ends arranged on an incline or curvature relative to the lid allowing for a progressive cutting of the lid.

2. The can opener of claim 1 wherein the plurality of teeth extend around the perimeter to a spaced gap opposite the at least one tooth with the projection.

3. The can opener of claim 1 wherein the body housing further comprises a top and a cylindrically shaped skirt extending inwardly from the top.

4. The can opener of claim 1 wherein one tooth oppositely spaced form the spaced gap has a cutting point extending inwardly deeper than the other teeth to provide an initial piercing of the lid prior to the remaining teeth.

5. The can opener of claim 1 wherein the cutting blade has the points of the teeth aligned linearly and inclined relative from the tooth with a projection to the spaced gap at an angle other than 0 degrees relative to a can lid.

6. The can opener of claim 1 wherein the cutting blade has the teeth aligned on a curved path relative to the lid.

7. The can opener of claim 1 wherein the cutting blade is affixed to the top of the body housing at an inside surface and spaced from the side skirts.

8. The can opener of claim 1 wherein the body housing is made of plastic, wood or metal.

9. The can opener of claim 1 wherein the cutting blade is made of metal or ceramic.

10. The can opener of claim 1 wherein the cutting blade is made of hardened metal having tungsten, carbide or diamond coated cutting edges with sharpened cutting edges having sharpened internal cutting surfaces or external cutting surfaces or both.
